(19) United States
(12) Patent Application Publication
(10) Pub. No.: US 2005/0033954 A1
(43) Pub. Date: Feb. 10, 2005

(54) Computer system having BIOS with multiple memory block

(76) Inventors: Cheng-Fan Wang, Hsin Tien City (TW); Cheng-Ju Tsai, Hsin Tien City (TW); Chun-Ta Chen, Hsin Tien City (TW)

Correspondence Address: BIRCH STEWART KOLASCH & BIRCH, PO BOX 747, FALLS CHURCH, VA, 22040-0747, US

(21) Appl. No.: 10/902,829

(22) Filed: Aug. 2, 2004

(30) Foreign Application Priority Data
Aug. 5, 2003 (TW) 092121374

(51) Int. Cl. G06F 15/177

(52) U.S. Cl. 713/2

(57) ABSTRACT

A computer system with multiple Basic Input/Output System (BIOS) memory blocks has an internal memory block and an external memory block for the use of single or dual BIOS. When the external memory block is damaged or incorrect, the computer system automatically copies the content of the internal memory block to the external memory block. The booting information stored in the internal memory block is not alterable by a user so that the internal memory block booting information will continuingly serve the purpose of duplicating itself to the damaged external memory block for providing an unlimited number of salvages to the external memory block serving as the primary source for computer booting.

### BACKGROUND OF THE INVENTION

1. Field of the Invention

The present invention relates to a computer system having a BIOS with multiple memory block, and more particularly, to a computer system having a BIOS with an external memory block and internal memory block. Furthermore, users cannot modify the information stored in the internal memory block, and thus computers can be booted or rebooted successfully as long as the information in the internal memory block remains intact.

2. Description of the Prior Art

Basic Input Output System (BIOS) stores the most fundamental basic input and output and self-check procedures when the power of the computer system is turned on. Currently, BIOS is always stored in erasable memories such as the flash memory, electrically erasable programmable read-only memory, and firmware hub. When the power of the computer system is turned on, the BIOS is loaded from the erasable memory and executed. Under these circumstances, a user can modify contents of BIOS for the purpose of updating the BIOS, but may also create errors in the BIOS, thus resulting in the stoppage of the computer system.

There are two solutions to above undesired consequences. In a single BIOS scheme, the BIOS includes a primary memory area for booting and a backup memory area. When the computer first starts up, the BIOS information in the primary memory area is copied to the backup memory area. As a result, if the BIOS information in the primary memory area cannot boot the computer, the BIOS information in the backup memory area kicks in to boot the computer.

Reference is made to FIG. 1, which is an operational flow chart for a single BIOS scheme. Power of the computer system is turned on (S10); the content of BIOS is changed because of an update, a virus infection or loading of incorrect BIOS information (S12); the computer is reset (reboot) (S14); the BIOS information in the primary memory area is loaded (S16) if the computer starts up successfully (S20); otherwise the BIOS information in the backup memory area is loaded (S18); if the BIOS information in the backup memory area is accurate, the computer starts up successfully (S22); otherwise the computer fails to start up (S24).

However, if the content of BIOS is changed because of incorrect BIOS updating, virus infection, or loading of incorrect BIOS information, even with the step of copying the BIOS information in the primary memory area to the backup one, the copied BIOS information in the backup memory area is still not correct. Consequently, the computer cannot start up. Another undesired scenario involves damage to the backup memory area in addition to damage to the primary memory area when switching to the backup memory area for the purpose of booting, meaning the computer cannot to start up.

On the other end, a dual BIOS motherboard includes determining and selecting circuits for selecting the other BIOS to start up the computer when one BIOS is damaged. Reference is made to FIG. 2 of an operational flow chart of a dual BIOS computer system. Power of the computer is turned on (S30); the content of one BIOS is changed As a result, of version updating, virus infection, or loading of incorrect BIOS information (S32); after the computer is reset (S34), the BIOS information in one BIOS is loaded (S36); the computer starts up successfully if the BIOS loaded in the BIOS is successful (S40); otherwise, the BIOS information in the other BIOS is loaded (S38); if this BIOS information is accurate the computer starts up successfully (S42); otherwise, the computer fails to start up (S44).

The advantage of dual BIOS setting is that when one BIOS is damaged, the other BIOS steps in for computer booting. But the BIOS only available at that point is damaged when users incorrectly update the BIOS, negligently allow a virus to infect the BIOS, or load incorrect BIOS information into the BIOS. The use of another BIOS and the addition of determining and selecting circuits raises the total manufacturing cost and makes the system maintenance and operation more complicated.

### SUMMARY OF THE INVENTION

It is therefore a primary objective of the present invention to provide a computer system having a BIOS with multiple memory blocks to provide an unlimited salvage mechanism when the BIOS is incorrect. As a result, not only consumers but also wholesalers can avoid total damages to BIOS chips to save time and cost for replacements.

In accordance with the claimed invention, the present invention provides a multiple memory block basic input output system (BIOS) having an external memory block storing a first booting information for the use of computer booting and an internal memory block storing a second booting information for providing an alternative to the computer booting when the first booting information is not available. Computers pick up the first booting information instead of the second booting information for booting when the power thereof has been turned on and no hardware of the BIOS is out of work so that information stored in the internal memory block remains intact and secured.

It is an advantage of the present invention that the present BIOS has both external and internal memory blocks and the booting information stored in the internal memory block is used as an alternative when the booting information stored in the external memory block is not available so as to solve the problem that computers are unable to start up because of damage to BIOS.

Another advantage of the present invention is the provision of a set of predetermined specific strings of words for checking manufacturer information, motherboard brand names, and BIOS versions and dates, thereby avoiding the situation where a user updates the BIOS with incorrect BIOS versions.

It is another advantage of the present invention that, in the application programs provided to a client, only the external memory block booting information, rather than the counterpart in the internal memory block, can be modified. Manufacturers, however, can modify both external and internal memory block booting information. Therefore, the booting information in the internal memory block remains intact and the BIOS version can be updated only through the manufacturers to meet the needs of consumers and purchasers.

These and other objectives of the present invention will no doubt become obvious to those of ordinary skill in the art after reading the following detailed description of the preferred embodiment that is illustrated in the various figurers and drawings.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an operational flow chart for a conventional single BIOS motherboard;

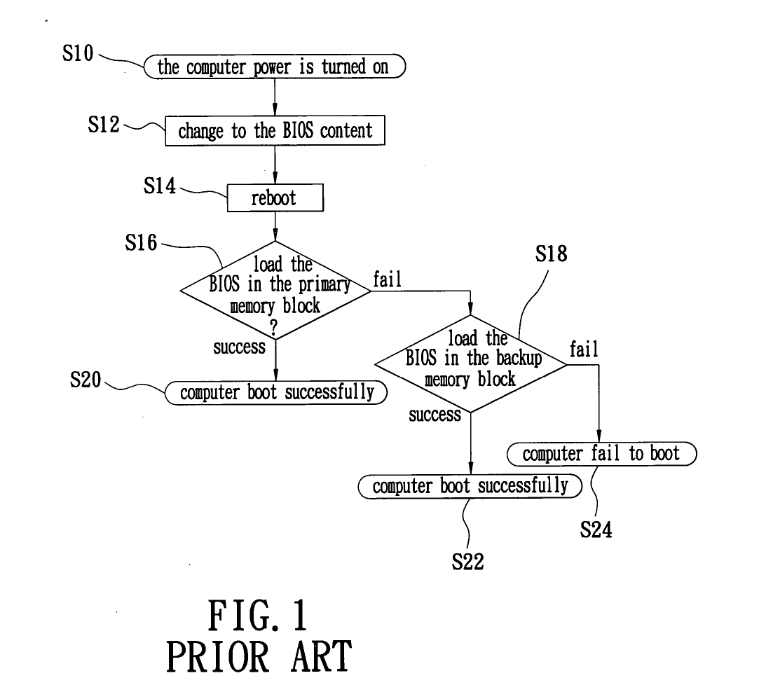

FIG. 2 is an operational flow chart for a conventional dual BIOS motherboard;

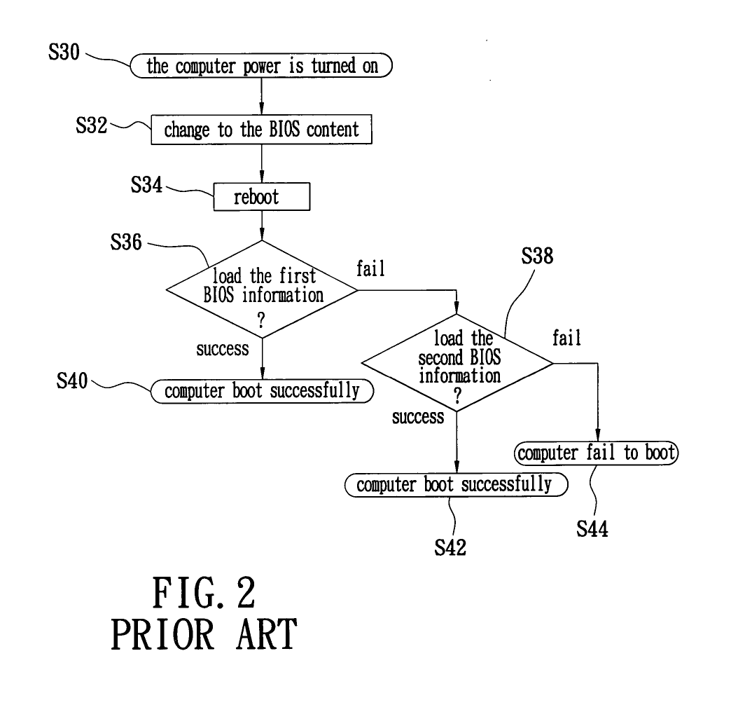

FIG. 3 is an operational flow chart for the present invention BIOS;

FIG. 4 is a schematic diagram for the application of the present invention to the single BIOS scheme;

FIG. 5 is an operational flow chart for the application of the present invention to the single BIOS scheme;

FIGS. 6A and 6B are schematic diagrams for the application of the present invention to the dual BIOS scheme;

FIG. 7 is an operational flow chart for the application of the present invention to the dual BIOS scheme;

FIG. 8 is a schematic diagram illustrating the first embodiment according to the present invention; and

FIG. 9 is a schematic diagram showing the second embodiment according to the present invention.

### DETAILED DESCRIPTION OF THE PREFERRED EMBODIMENT

The present invention discloses a multiple memory block BIOS having external and internal memory blocks. The external memory block stores the general booting information (first booting information) while the internal memory block stores the fundamental booting information (second booting information).

Every time the power of the computer is turned on, only the first booting information is loaded. If the first booting information is damaged or incorrect, the second booting information will be copied to the external memory block. Therefore, the external memory block continues to serve the purpose of computer booting by the copied second booting information if the first booting information is damaged or incorrect. Additionally, the second booting information is kept intact, thereby providing an unlimited salvage mechanism for the damaged external memory block.

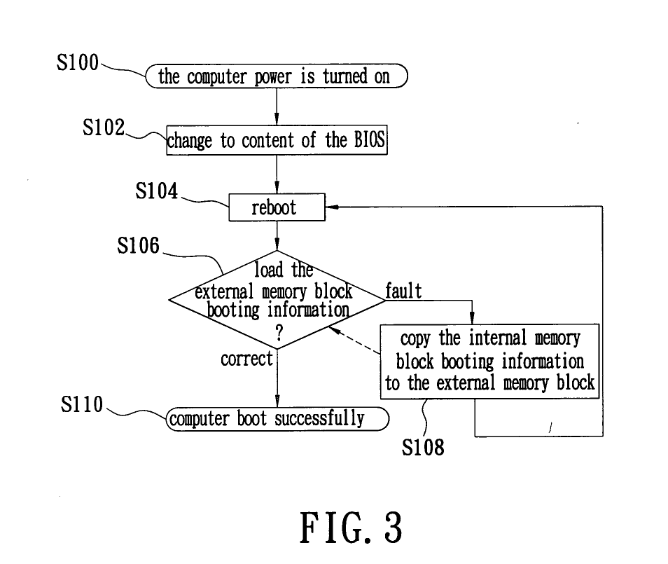

Reference is made to FIG. 3, which is an operational flow chart with respect to the present invention BIOS. The power of the computer is turned on (S100), the content of BIOS is changed by BIOS version updating, virus infection or loading incorrect BIOS information to change the external memory block BIOS information (S102), and the external memory block booting information is loaded to determine if it can start up the computer successfully (S106) after the computer is reset (S104). If changes to the external memory block booting information are correct, the computer is started up easily (S110); otherwise, the internal memory block booting information is automatically copied to the external memory block (S108) to start the computer successfully. There are no limitations when it comes to the number of times the internal memory block booting information is copied to the external memory block.

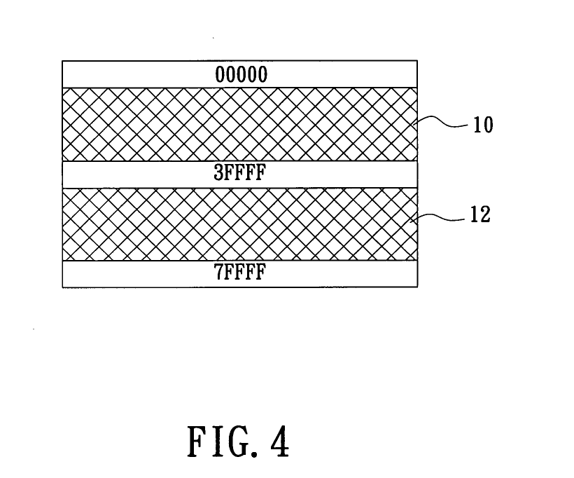

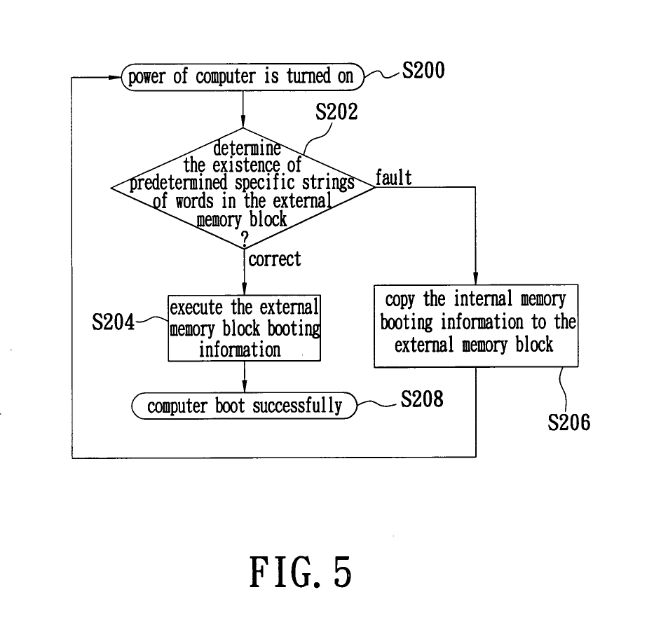

The present invention includes either a single or plural BIOS scheme. Reference is made to FIGS. 4 and 5, in which a single BIOS provides the external and internal memory blocks. Manufacturers define the address 40000-7FFFF as the external memory block 12 for storing the first booting information and the address 00000-3FFFFF as the internal memory block 10 for storing the second booting information to provide an alternative to the computer booting if the first booting information is unable to start up the computer successfully.

Reference is made to FIG. 5, which is an operational flow chart for a single BIOS. When the computer power is turned on (S200), only the BIOS information stored in address 40000-7FFFF is used and altered. A determining program determines if predetermined specific strings of words exist in the external memory block booting information, and therefore decides if the external memory block booting information is “damaged” as a result of BIOS version updating, virus infection or incorrect BIOS information loading.

If predetermined specific strings of words exist in the external memory block booting information, the external memory block booting information located at address 40000-7FFFF is executed (S204) to start up the computer successfully (S208). If that is not the case, the internal memory block booting information stored at address 00000-3FFFF is copied to the external memory block (S206). Thereafter, the computer uses the copied second booting information originally stored in the internal memory block but right now copied to the external memory block in the course of resetting so as to ensure a successful computer booting and automatically fix booting information errors in the external memory block.

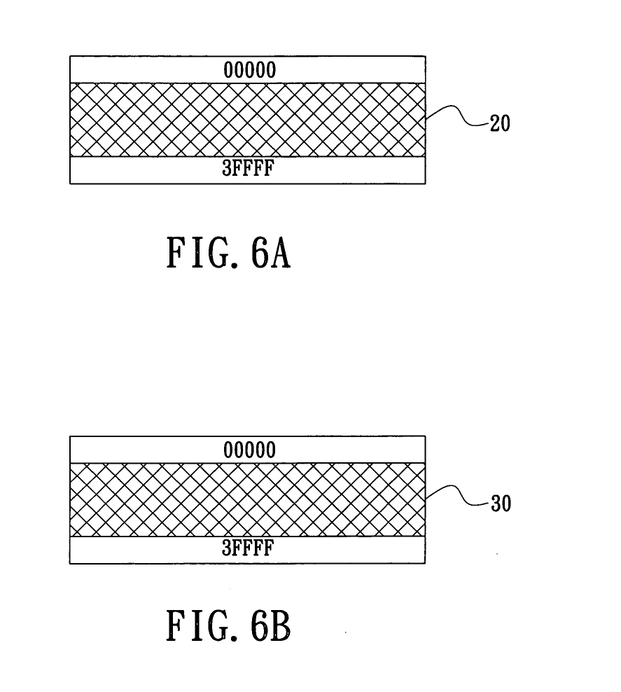

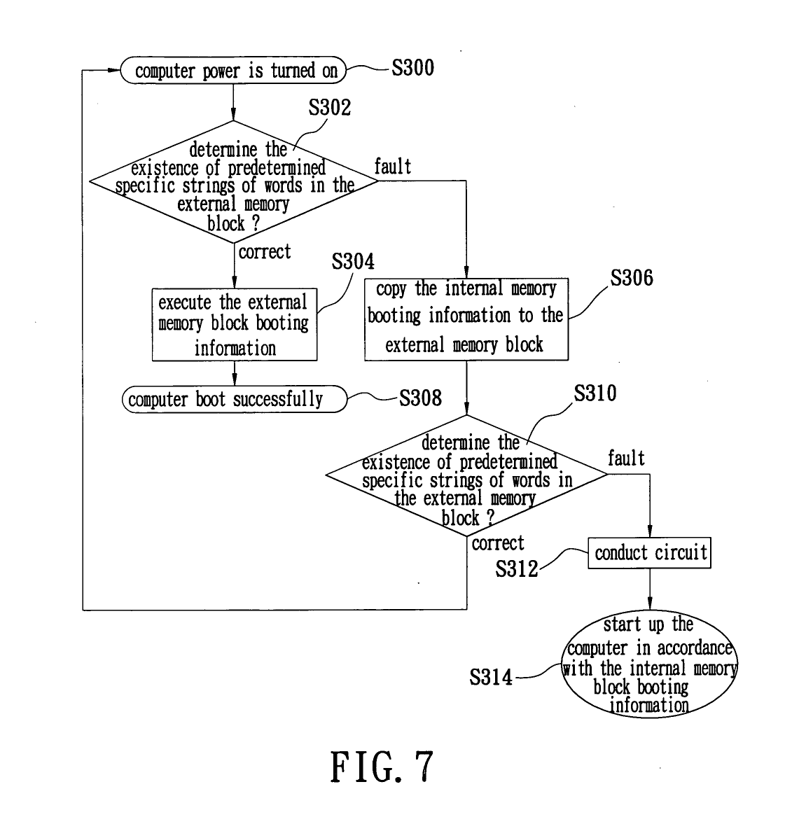

Reference is made to FIGS. 6 and 7, which illustrate a dual BIOS scheme according to the present invention. Different BIOS chips provide the external and internal memory blocks, respectively. FIG. 6 illustrates a dual BIOS scheme and defines one BIOS as the external memory block 20 in FIG. 6A for computer booting and the other BIOS as the internal memory block 30 (FIG. 6B) for salvaging the external memory block when the booting information stored in the external memory block fails to start up the computer.

FIG. 7 illustrates the operational flow for the dual BIOS. When the computer power is turned on (S300) only the external memory block booting information (first booting information) is used and altered if there is any change to the BIOS. A determining chip serves to find out if predetermined specific strings of words exist (S302) so as to acknowledge if there is any damage to the external memory block booting information as a result of BIOS version updating, virus infection or loading incorrect BIOS information.

If predetermined specific strings of words exist, the first booting information (external memory block booting information) is executed (S304) so as to start up the computer start up (S308). If not, the second booting information stored in the internal memory block is copied to the external memory block (S306). The determining chip continues to check for the existence of the predetermined specific strings of words so as to determine whether the fixed external memory block booting information after duplication from the internal memory block booting information is correct or not (S310). If correct, the computer reboots and then is started up successfully; otherwise, the internal memory block booting information kicks in (S314) by short-circuiting corresponding circuits.

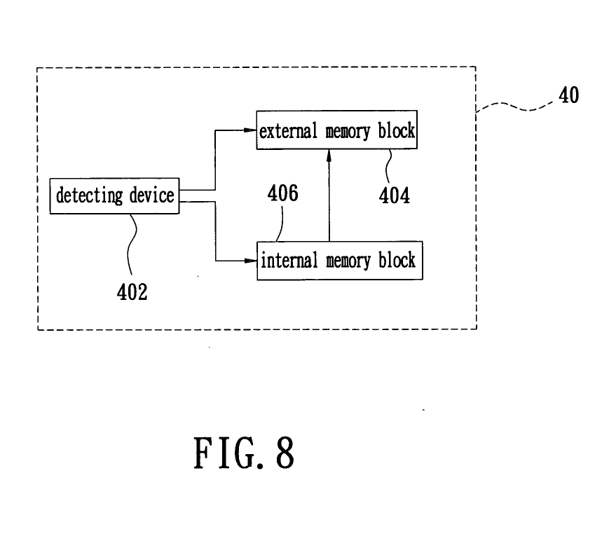

Reference is made to FIG. 8, which illustrates a first preferred embodiment for a computer system based on the present invention. The computer system 40 includes an external memory block 404 for storing a first BIOS having a first booting information for the use of ordinary computer booting, an internal memory block 406 for storing a backup BIOS having a second booting information, and a detecting device 402 for detecting whether the first booting information is “damaged” or not.

If the external memory block 404 is not damaged, the computer system loads the booting information stored in the external memory block 404 for booting. On the other end, if the external memory block 404 is damaged, the computer system copies the backup (second) booting information stored in the internal memory block 406 to the external memory block 404 so as to provide the booting information for rebooting.

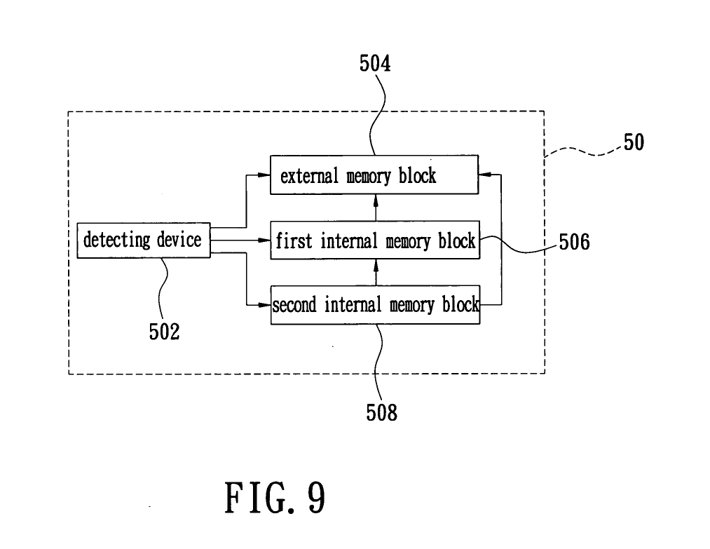

Reference is made to FIG. 9, which illustrates a second embodiment in accordance with the present invention. The computer system 50 in FIG. 9 includes an external memory block 504 for storing a BIOS having a first booting information for ordinary computer booting, a first and a second internal memory blocks 506 and 508 for storing backup BIOS having second booting information, and a detecting device 502 for detecting whether the first booting information (or the external memory block) is “damaged.”

When the external memory block 504 suffers no damage, the computer system 50 loads the first booting information stored in the external memory block 504 for booting. If the external memory block 504 is damaged, the computer system 50 copies the second booting information stored in the first internal memory block 506 to the external memory block 504 so as to provide the booting information for rebooting. Even if the external and first internal memory blocks 504 and 506 are both damaged, the computer system 50 turns to the second booting information stored in the second internal memory block and copies the second booting information therein to the external and the first internal memory blocks 504 and 506 for rebooting.

In above two embodiments, application programs are provided to clients and manufacturers, in which only the external memory block booting information of the client application programs can be modified and both external and internal memory block booting information of manufacturer application programs can be modified. Consequently, a user cannot change the internal memory block booting information but manufacturers are able to update the BIOS version to meet the needs of users (purchasers).

To sum up, the present invention has the advantage of being able to copy the internal memory block information an unlimited number of time to the external memory block for preventing computers from stopping in cases of virus infection, erroneous BIOS updating process, and loading incorrect BIOS version, all of which lead damage the booting memory block. Additionally, the backup booting information is only duplicated to the booting memory block and remains unchanged so as to provide an unlimited number of salvages. The advantage of the present invention further includes preservation of the integrity of BIOS information by defining two separate memory blocks and restricting the external booting information as the sole source for the computer booting. In this situation, even if the BIOS information is incorrect, only the external memory block is affected, securing the integrity of the internal memory block booting information. The conventional BIOS salvage method uses multiple BIOS booting areas in succession to start up for booting, but if errors damage the booting information and last for a long period of time, every successive started-up booting area is damaged in a successive manner. Consequently, all available booting information eventually becomes unavailable and thus the computer cannot start up anymore. Another advantage of the present invention is the compatibility with current motherboards. The present invention is available for single or dual BIOS motherboard. In the case of a single BIOS scheme, no addition or modification to the current motherboards is required to fix automatically a “damaged” BIOS and conflicting BIOS versions. In the case of a dual BIOS scheme, while the hardware of the external memory block is out of work the internal memory block becomes the “official external memory block” to take over the duty of computer booting. Another advantage of the present invention is the accuracy check by placing predetermined specific strings of words in the BIOS booting information to provide the correct manufacturer information, brand names, and BIOS Versions and dates for preventing loading of the incorrect version when users update their BIOS. Another advantage of the present invention is to save time and cost for users and wholesalers on BIOS damages.

The external memory block is preferably is a flash memory, an electrical erasable read-only memory, or a firmware hub, while the internal memory block is preferably a mask read-only memory, programmable read-only memory, or erasable programmable read-only memory.

Those skilled in the art will readily observe that numerous modifications and alterations of the device may be made while retaining the teachings of the invention. Accordingly, the above disclosure should be construed as limited by the metes and bounds of the appended claims.

1. A computer system having a BIOS with multiple memory blocks, comprising:
an external memory block storing a first booting information of the BIOS for computer booting;
an internal memory block storing a second booting information of the BIOS for providing an alternative for computer booting when the first booting information is not available; and
a detecting device detecting whether the first booting information is “damaged” or not;
whereby a computer system loads the first booting information stored in the external memory block for booting, if the computer crashes and the external memory block is not damaged. On the other end, if the external memory block is damaged, the computer system copies the second booting information stored in the internal memory block to the external memory block so as to provide the booting information for rebooting.

2. The computer system of claim 1, wherein the detecting device detects whether booting solely relying on the first booting information is successful or not and copying the second booting information to the external memory block if the first booting information fails to boot the computer, the computer rebooting in accordance with the copied second booting information.

3. The computer system of claim 1, wherein the first booting information comprises predetermined specific strings of words for checking manufacturer information, motherboard brand name, BIOS version and BIOS date.

4. The computer system of claim 1 wherein the first booting information is refreshable by BIOS refreshing software.

5. The computer system of claim 1, wherein the second booting information is configured when a computer leaves a manufacturer thereof.

6. The computer system of claim 1, wherein the external and internal memory blocks are physically separated in a single BIOS scheme.

7. The computer system of claim 1, wherein the external and internal memory blocks are provided by first and second BIOS schemes, respectively.

8. The computer system of claim 1, wherein the external and internal memory blocks are provided by a dual BIOS scheme, respectively; the internal has a first internal memory block storing a second booting information of the BIOS for providing the alternative for computer booting when the first booting information is not available, when the internal memory blocks are damaged, the computer system turns to the second booting information stored in the first internal memory block and copies the second booting information therein to the external memory blocks for rebooting.

9. The computer system of claim 1, wherein the external memory block and the internal memory block preferably are a flash memory, an electrical erasable read-only memory, or a mask read-only memory.

10. A computer booting method incorporating a multiple memory block BIOS chip, wherein the multiple memory block BIOS chip includes an external memory block and an internal memory block, comprising:
determining if predetermined specific strings of words exist in the external memory block of the BIOS when the computer is first booted;
executing a first booting information in the external memory block when the predetermined specific strings of words exist; and
copying a second booting information in the internal memory block to the external memory block if no predetermined specific strings of words exist in the external memory block and rebooting the computer in accordance with the second booting information copied in the external memory block.

11. The booting method of claim 10, wherein the predetermined specific strings of words includes manufacturer information, motherboard brand name, BIOS version and BIOS date.

12. The booting method of claim 10, wherein the first booting information in the external memory block is refreshable by a BIOS refreshing software.

13. The booting method of claim 10, wherein the second booting information is already configured when a computer leaves a manufacturer thereof.

14. A computer booting method incorporating a multiple memory block BIOS having a first BIOS chip for storing an external memory block booting information and a second BIOS chip for storing an internal memory block booting information, the method comprising:
determining if predetermined specific strings of words exist in the external memory block booting information when a computer is first booted;
executing the external memory block booting information if the predetermined specific strings of words exist; and
copying the internal memory block booting information to the first BIOS chip to replace the external memory booting information when no predetermined specific strings of words exist.

15. The computer booting method of claim 14, wherein copying the internal memory block booting information to the first BIOS chip further comprises steps:
determining if the predetermined specific strings of words of a refreshed external memory block booting information exist in the first BIOS chip;
rebooting the computer in accordance with the refreshed external memory block booting information if the predetermined specific strings of words exist in the external memory block booting information; and
rebooting the computer in accordance with the internal memory block booting information if no predetermined specific strings of words exist in the refreshed external memory block.

16. The booting method of claim 14, wherein the predetermined specific strings of words include manufacturer information, motherboard brand name, BIOS version and BIOS date.

17. The booting method of claim 14, wherein the external memory block booting information is refreshable by a BIOS refreshing software.

18. The booting method of claim 14, wherein the internal memory block booting information is configured when a computer leaves a manufacturer thereof.
